(19) United States
(12) Patent Application Publication
(10) Pub. No.: US 2024/0302189 A1
(43) Pub. Date: Sep. 12, 2024

(54) DEVICES, SYSTEMS, AND METHODS FOR CONTROLLING THE POSITION OF ELECTRIC MOTORS

(71) Applicant: JMX AUDIO PTY LIMITED, Hornsby, New South Wales (AU)

(72) Inventors: Ian OVERLIESE, Hornsby (AU); David KLOPSTEINS, Hornsby (AU)

(73) Assignee: JMX AUDIO PTY LIMITED, Hornsby, New South Wales (AU)

(21) Appl. No.: 18/573,745

(22) PCT Filed: Jun. 25, 2022
(86) PCT No.: PCT/AU2022/050654

§ 371 Date: Dec. 22, 2023

(30) Foreign Application Priority Data
Jun. 25, 2021 (AU) 2021901927

(51) Int. Cl. G01D 5/347; H02K 11/22

(52) U.S. Cl. CPC G01D 5/34784; H02K 11/22; G01D 2205/26; H02K 2211/03

(57) ABSTRACT

Disclosed is an optical position encoder system for use with an electric motor that comprises at least one sinusoidal gradient having a dark to light pattern on at least one surface thereof and a control board affixed to the motor to at least in part control the motor's movement. The control board comprises a light source and at least two light sensors positioned on the control board. The light source and at least two light sensors are spaced apart from each other. The light source directs light onto the at least one sinusoidal gradient. The at least two light sensors receive reflected light from the at least one sinusoidal gradient and provide at least two output signals. At least one microprocessor connected to the motor receives the at least two output signals and uses those signals to determine at least in part the motor's movement, position, or a combination thereof.

### TECHNICAL FIELD

The present disclosure generally relates to devices, systems and/or methods that may be used for controlling the position of electric motors, using position encoders.

### CROSS REFERENCE TO RELATED MATERIALS

This application claims priority to Australian Provisional Application No. 2021901927, entitled “Devices, Systems, and Methods for Controlling the Position of Electric Motors” filed on 25 Jun. 2021. This Australian Provisional Application is incorporated herein by reference in its entirety.

### BACKGROUND ART

Optical encoders used with electric motors have a number of different functions and may be used on a number of different devices and systems.

Optical encoders are typically employed as motion detectors in applications such as closed-loop feedback control in a motor control system. Typical existing optical encoders are configured to translate rotary motion or linear motion into digital output for position encoding using corresponding code wheels or code strips. In short, an optical encoder is an electromechanical device or system that has an electrical output in digital form proportional to the angular position of the input shaft.

Typically, an optical encoder is an angular position sensor; it has a shaft mechanically coupled to an input driver, which rotates a disc rigidly fixed to it. A succession of opaque and clear segments are marked on the surface of the disc. Existing Optical Patterns use a binary level encoding, i.e., either black or white. This either sets the transducer's output to a minimum or maximum level. The optical pattern may be reflective or transmissive. Light from infrared emitting diodes reaches the infrared receivers through the transparent slits of the rotating disc. An analog or digital signal is created. Then electronically, the signal is amplified and converted into digital form. This signal is then transmitted to the data processor. With this binary information, the position may be located either somewhere in the black region or somewhere in the white region.

The precision of the optical encoder is a useful function. In existing optical encoders, to increase the precision of the position, the number of black and white pairs is increased. The existing extension to this, which gives, in principle, infinite resolution, is to place a reticule mask in between the transducers (detectors) and that once the size of the black and white pairs gets small enough, the lens in the optical transducer will not be able to resolve the black and white, and instead will produce a triangular output, where the maximum and minimum points on the triangular signal correspond to each black and white markings. In preference to a triangular signal, a sinusoidal position signal may also be used. A number of known methods may achieve this. Many of these methods use, for example, the Moiré effect and require very high precision components that are expensive to use.

There is a need in the art for high accuracy position encoders that may be produced at a very low cost. The present disclosure is directed to overcome and/or ameliorate at least one or more of the disadvantages of the prior art, as will become apparent from the discussion herein. The present disclosure also provides other advantages and/or improvements as discussed herein.

### SUMMARY OF THE DISCLOSURE

This summary is not meant to cover each and every embodiment; combination or variations that are contemplated with the present disclosure. Additional embodiments are disclosed in the detailed description, drawings, and claims.

At least one embodiment is directed to using a sinusoidal gradient pattern in conjunction with a multi-phase electric motor to determine at least in part the motor's movement, position or combinations thereof.

At least one embodiment is directed to using a sinusoidal gradient pattern, and optionally calibration to achieve a high accuracy position encoder at a very low cost by repeating a sinusoid multiple times to increase the change in light level to position ratio, thereby increasing signal to noise ratio and allowing more accurate position determination.

At least one embodiment is directed to an optical position encoder system comprising: at least one sinusoidal gradient for use with an electric motor, the at least one sinusoidal gradient having a dark to light pattern on at least one surface of the at least one gradient; and a control board configured to be affixed to the motor and to at least in part control the motor's movement, the control board comprising: a light source and at least two light sensors position on a planar side of the control board, the at least two light sensors being spaced at a distance apart from each other and the light source, wherein the light source is configured to direct light onto the at least one sinusoidal gradient's dark to light pattern, and the at least two light sensors are configured receive reflected light from the at least one sinusoidal gradient and provide at least two output signals; and at least one microprocessor operatively connected to the motor, the at least one microprocessor being configured to receive the at least two output signals from the at least two sensors and used those signals to determine at least in part the motor's movement, position or combinations thereof.

At least one embodiment is directed to an optical position encoder system comprising: at least one sinusoidal gradient that is configured to be positioned on a surface of a multi-phase electric motor, the sinusoidal gradient having a dark to light pattern on at least one surface of the at least one gradient; and a control board configured to be affixed to the motor and to at least in part control the motor's movement, position or combinations thereof, the control board comprising: a light source and at least two light sensors position on a planar side of the control board, the at least two light sensors being spaced at a distance apart from each other and the light source, wherein the light source is configured to direct light onto the at least one sinusoidal gradient's dark to light pattern, and the at least two light sensors are configured receive reflected light from the at least one sinusoidal gradient ramp and provide at least two output signals; and at least one microprocessor operatively connected to the motor, the at least one microprocessor being configured to receive the at least two output signals from the at least two sensors and used those signals to determine the motor's movement, position or combinations thereof.

At least one embodiment is directed to an optical position encoder system comprising: at least one sinusoidal gradient that is configured to be positioned on a surface of a multi-phase electric motor, the at least one sinusoidal gradient having a dark to light pattern on at least one surface of the at least one sinusoidal gradient; and a control board configured to be affixed to the motor and to at least in part control the motor's movement, position or combinations thereof, the control board comprising: a light source and at least two light sensors position on a planar side of the control board, the at least two light sensors being spaced at a distance apart from each other and the light source, wherein the light source is configured to direct light onto the sinusoidal gradient's dark to light pattern, and the at least two light sensors are configured receive reflected light from the sinusoidal gradient and provide at least two output signals in quadrature phase; at least one microprocessor operatively connected to the motor, the at least one microprocessor being configured to receive the at least two output electronic signals from the at least two sensors and used those signals to determine the motor's movement, position or combinations thereof; and wherein the system is configured to allow the reflected light from the gradient's light to dark pattern to be repeated a plurality times and use a plurality of the at least two output electronic signals in order to reduce the optical positions encoder's signal to noise ratio and to determine the motor's movement, position or combinations thereof.

At least one embodiment is directed to a method of using optical position encoder system to control a multi-phase electric motor, the method comprising: using a control board configured to be affixed to the motor and to at least in part control the motor's movement, the control board comprising: using a light source and at least two light sensors position on a planar side of the control board, the at least two light sensors being spaced at a distance apart from each other and the light source, wherein the light source is configured to direct light onto the at least one sinusoidal gradient's dark to light pattern, and the at least two light sensors are configured receive reflected light from the at least one sinusoidal gradient and provide at least two output signals; and using at least two light sensors to collect light signals from the reflect light off the at least one gradient, wherein the at least two light sensors are spaced from each other, converting the collected light signal into electronic signals by the at least two light sensors; sending the electronic signals to an electronic control system; and wherein the electronic control systems use the electronic signals to at least in part determined the position, movement of the electric motor.

At least one embodiment is directed to an optical position encoder comprising: a sinusoidal gradient ramp, at least one light source and at least two light sensors, wherein the at least two light sensors are set a defined distance apart and are configured to provide at least two output signals in a quadrature phase; wherein the optical position encoder is configured to allow a sinusoid to be repeated a plurality of times, in order to improve the optical position encoder's signal to noise ratio; and wherein the optical position encoder has at least one peak or trough of the sinusoids extended in amplitude.

### BRIEF DESCRIPTION OF THE DRAWINGS

FIG. 1A illustrates an existing prior art optical pattern that uses a binary level encoding, for example, either black or white.

FIG. 1B illustrates a circular continuous tone sinusoidal gradient of alternating dark areas and light areas, according to at least one exemplary embodiment.

FIG. 2A illustrates a continuous tone sinusoidal gradient of alternating dark areas and light areas, according to at least one exemplary embodiment.

FIG. 2B illustrates an enlarged portion of the continuous tone sinusoidal gradient of alternating dark areas and light areas of FIG. 2A and a schematic of how the optical decoder processes light, according to at least one exemplary embodiment.

FIG. 3A-1 illustrates a schematic drawing of an electric motor with an optical decoder that uses circular continuous tone sinusoidal gradient of alternating dark areas and light areas, and which in use is operably connected to a control board as depicted in FIG. 3A-2, according to at least one exemplary embodiment.

FIG. 3A-2 illustrates a schematic drawing of a control board, which in use is operably connected to an electric motor with an optical decoder that uses circular continuous tone sinusoidal gradient of alternating dark areas and light areas as depicted in FIG. 3A-1, according to at least one exemplary embodiment.

FIG. 3B illustrates a rear view of the electric motor with an optical decoder that uses circular continuous tone sinusoidal gradient of alternating dark areas and light areas as depicted in FIG. 3A-1, along with the control board as depicted in FIG. 3A-2, the control board now shown attached to the electric motor, according to at least one exemplary embodiment.

FIG. 4 shows an example of a rotary motor using a radially mounted sinusoidal gradient encoder of alternating dark areas and light areas, according to at least one exemplary embodiment.

FIG. 5-1 illustrates a portion of an exploded view of a linear electric motor depicting a sinusoidal gradient encoder of alternating dark areas and light areas located on the underside of a cover of the electric motor, which in use is operably connected with a slidable actuator as depicted in FIG. 5-2, and also with a permanent magnet as depicted in FIG. 5-3, according to at least one exemplary embodiment.

FIG. 5-2 illustrates a portion of an exploded schematic view of a linear electric motor depicting a slidable actuator which has a light source and at least two light sensors, which in use is operably connected to a sinusoidal gradient encoder of alternating dark areas and light areas as depicted in FIG. 5-1, and also with a permanent magnet as depicted in FIG. 5-3, according to at least one exemplary embodiment.

FIG. 5-3 illustrates a portion of an exploded view of a linear electric motor depicting a permanent magnet which is arrangeable in use along the length of the electric motor, which in use is operably connected to a sinusoidal gradient encoder of alternating dark areas and light areas as depicted in FIG. 5-1, and also with a slidable actuator as depicted in FIG. 5-2, according to at least one exemplary embodiment.

FIG. 6 illustrates a linear continuous tone sinusoidal gradient of alternating dark areas and light areas, according to at least one exemplary embodiment.

FIG. 7 illustrates a control panel (mixing board) for sound applications where the electric motors use the optical encoder, according to at least one exemplary embodiment.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting but merely as a representative basis for teaching one skilled in the art to variously employ the disclosed embodiments and variations of those embodiments.

The subject headings used in the detailed description are included only for the reader's ease of reference and should not be used to limit the subject matter found throughout the disclosure or the claims. The subject headings should not be used in construing the scope of the claims or the claim limitations.

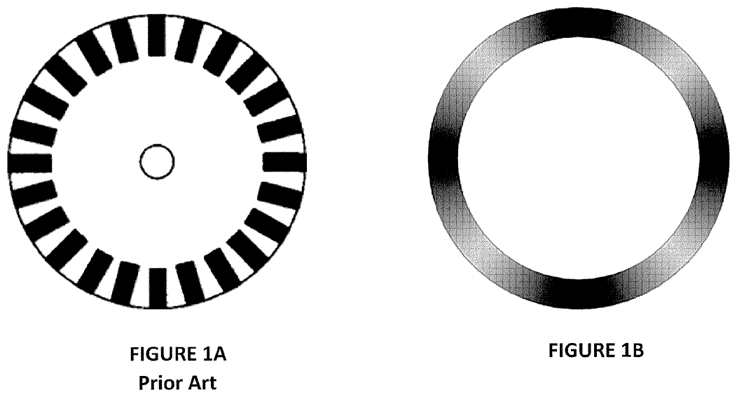

FIG. 1A show a typical prior art optical pattern that uses a binary level encoding, for example, black or white. This binary optical pattern sets the transducer's output to a minimum or maximum level. With this binary information, the position may be located either somewhere in the black region or somewhere in the white region. To increase precision of the position, the number of black and white pairs is increased. However, once the size of the black and white pairs gets narrow enough, the lens in the optical transducer typically will not be able to resolve the black and white. In the alternative, very high-end optical transducers may be able to resolve the narrow black and white pattern; however, this makes the cost for each electric motor to become prohibitive for many applications. Many applications, for example, a control board set up for a sound recording studio, may use dozens of electric motors, thus making the control board set-up prohibitive in price.

FIG. 1B shows a continuous vary tone sinusoidal gradient of alternating dark areas and light areas, according to exemplary embodiments. The sinusoidal gradient shown in FIG. 1B shows a gradual shift from an alternating darker area to a lighter area and then back to a lighter area. In at least one embodiment, the sinusoidal gradient may be mounted on the outer casing of the electric motor. In at least one embodiment, the sinusoidal gradient may be mounted on a surface that is not the surface of the electric motor. The sinusoidal gradient may be printed like a label and then removed and pasted or attached to another surface that the optical encoder system will use to generate output signals. In at least one embodiment, the sinusoidal gradient may be printed or etched directly on a surface that may be used with the optical encoder. For example, the gradient may be printed or etched on the outer casing of an electric motor. It may be the outer casing of the electric motor. The sinusoidal gradient may be reflective, transmissive, or combinations thereof. Those skilled in the art know that sinusoidal gradient may deviate from a true sinusoidal gradient due to the limitations of printing processes used in mass production. This may require a calibration step to measure the nonideality, for example, when first commissioning the motor for use, and store the result of this for use when the motor is operating.

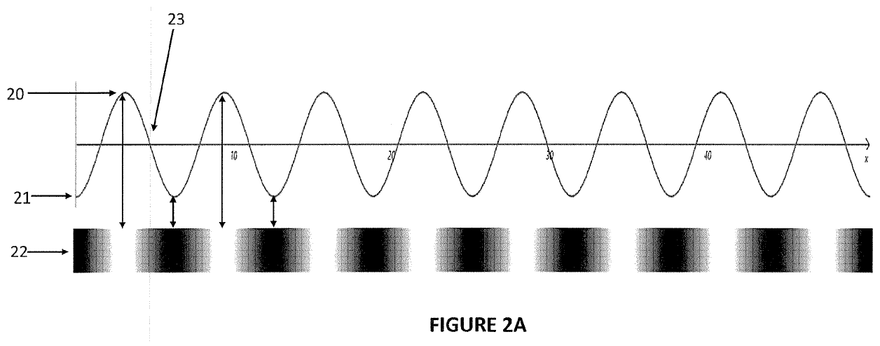

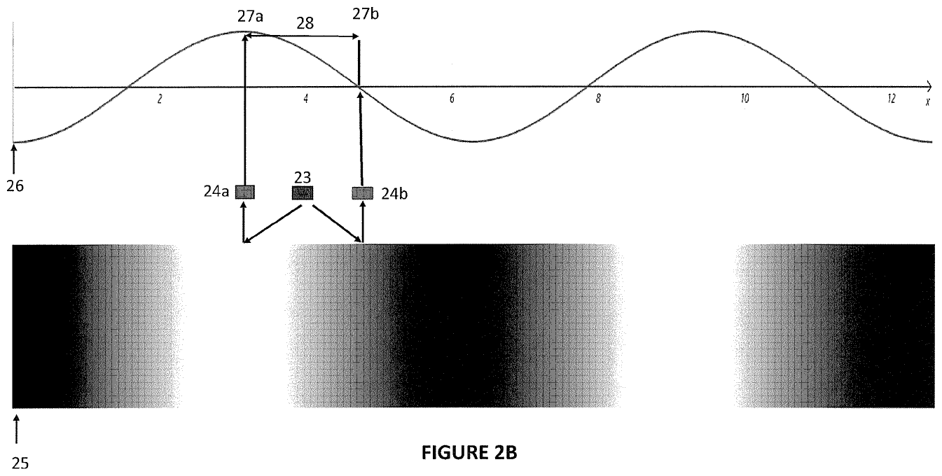

In at least one embodiment, the sinusoidal gradient may be used with at least two light sensors placed at a spacing that gives at least two readings at the quadrature phase (90 degrees) to each other. In at least one embodiment, the sinusoidal gradient may be used with at least two light sensors placed at a spacing that gives at least two readings at a substantial quadrature phase (substantially 90 degrees) to each other. In at least one embodiment, the sinusoidal gradient may be used with at least two light sensors placed at a spacing that gives at least two readings at about a quadrature phase (about 90 degrees) to each other. FIG. 2A and FIG. 2B illustrate this approach. FIG. 2A shows a linear sinusoidal gradient (22) and the sine wave (23) that may be generated. The linear sinusoidal gradient may start at both ends with a darker area or a lighter area, or one end being a lighter area and one end being a darker area. The principles around the linear sinusoidal gradient also apply to a circular sinusoidal gradient, as shown in FIG. 1B. In this exemplary embodiment, the sine wave represents the intensity of light reflected, with (21) being the darkest and (20) being the lightest and representing the most light reflected. In this example, a varying density pattern (22) is printed onto a substrate, such that the density varies from a darkest to lightest point. The variation of the progression from darkest to lightest, is sinusoidal with the position being sensed on the sinusoidal gradient.

In at least one embodiment, the sinusoidal pattern may be repeated multiple times across the encoder range. In order to find datum, i.e., determine the absolute position (or substantial absolute position) over the range, one of the sinusoidal peaks or troughs is extended. Quadrature phase encoding has the advantage that these peaks may not affect (or substantially affect) measurement position accuracy, as the position is determined by the ratio of the two sensor readings. Both sensors receive the same peak or trough, so the effect on the position measurement is substantially removed or removed (k*A)/(k*B)=A/B, regardless of ‘k’. This configuration is illustrated in FIG. 2B. FIG. 2B illustrates an enlarged portion of the continuous tone sinusoidal gradient of alternating dark areas and light areas of FIG. 2A and a schematic of how the optical decoder processes light, according to at least one exemplary embodiment. In this exemplary embodiment, a light source (23) shines onto the sinusoidal gradient pattern (25). The four arrows under (24a), (23), and (24b) represent the rays of light being generated by the light source and the rays of light being reflect off the sinusoidal gradient pattern and back to the two sensors. Light is reflected from (25) and is detected by (24a) and (24b) at their physical locations above (25). The intensities of light detected by (24a) and (24b) are (27a) and (27b). The distance between (24a) and (24b) is such that the distance on the sinusoidal wave (26) is a quarter of its wavelength (28) or about a quarter of its wavelength.

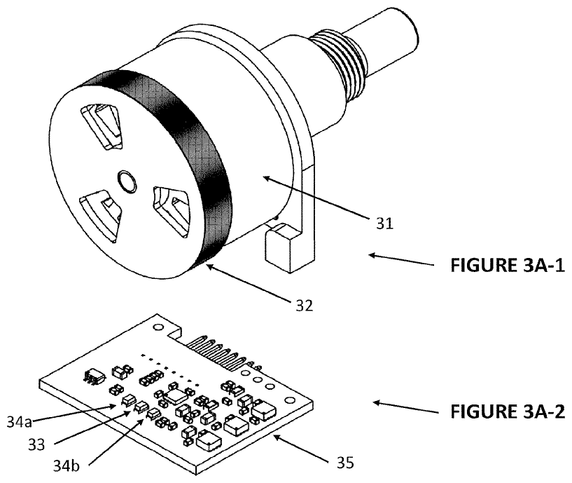

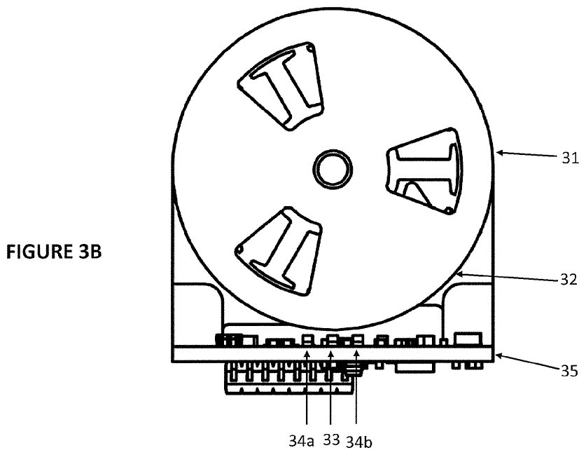

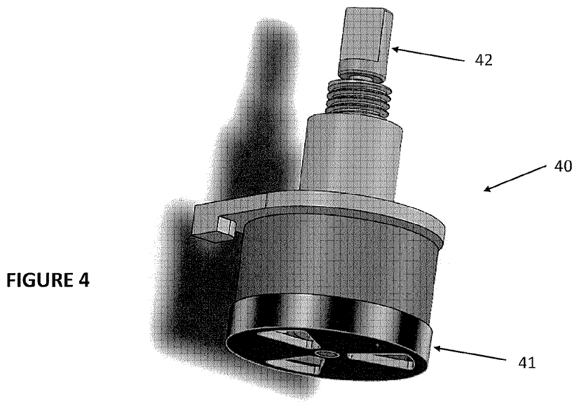

FIG. 3A-1 shows a schematic drawing of an electric motor (31) which has an optical decoder that uses using circular continuous tone sinusoidal gradient (32) of alternating dark areas and light areas, and FIG. 3A-2 shows a control board (35) exploded apart from the motor (31) but which in use is operably connected to said motor (31) of FIG. 3A-1, according to at least one exemplary embodiment. FIG. 3B is a rear view the electric motor (31) of FIG. 3A-1 but now with the control board (35) of FIG. 3A-2 attached to the electric motor (31). In the exemplary embodiment, the electric motor (31) comprises a set of permanent magnets and one or multiple wire coil windings (phases) arranged so that electrical current into the windings creates opposing magnetic fields to the permanent magnets, and thereby movement of the motor. In at least one embodiment, the motor may have a rotating configuration, as shown in FIG. 3A and FIG. 3B. In at least one embodiment, the motor may have a linear configuration, as shown in FIG. 4. In the FIG. 3A example, the sinusoidal gradient pattern (32), varying from light to dark, is attached to the body of the electric motor (31). The light source (33) typically may be infrared (IR) light, however, visible or ultraviolet (UV) light sources may also be used in one or more of the embodiments disclosed herein. The light source (33) may be a light-emitting diode (LED). However, other light sources are contemplated in the present disclosure. In this example, the light source is affixed to the control board. However, the light source does not have to be affixed to the control board and may be located in other places.

In use, the two light sensors (34a and 34b) shown measure the light reflected from the sinusoidal gradient pattern (32), originating from the light source (33). In this exemplary embodiment, the distance between sensors (34a) and (34b) may be chosen such that the reflected light received from one sensor is one quarter of a wave of the sinusoidal gradient, compared to the light received at the other sensor. In this example, the two light sensors may be affixed to the control board. However, the two light sensors do not have to be affixed to the control board and may be located in other places. A control system of electronics can be used to control the position and/or dynamic movement of the electric motor (31) by using the light readings from the sensors (34a) and (34b) and for controlling the electrical current into each of the phases in the motor (31). This is may a conventional control system, known in the art. In this example, a microprocessor is operatively connected to the motor where the microprocessor is configured to receive the at least two output electronic signals from the at least two sensors and to use those signals to determine the motor's movement, position, or combinations thereof.

FIG. 4 illustrates an electric rotary motor (40) using a radially mounted sinusoidal gradient encoder (41) of alternating dark areas and light areas, according to at least one exemplary embodiment. The sinusoidal gradient encoder (41) is located near the rear area of the motor housing, and the adjustment knob (42) is located at the front end of the rotary motor.

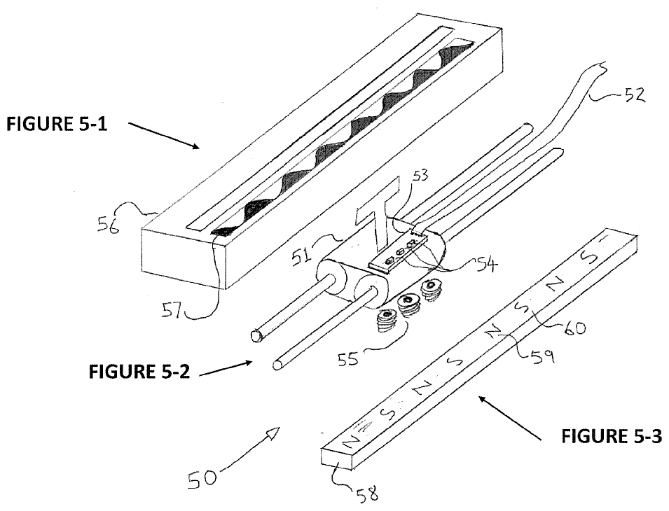

FIGS. 5-1, 5-2 and 5-3 together form an illustration of an exploded view of a linear electric motor (50) with a sinusoidal gradient encoder of alternating dark areas and light areas, according to at least one exemplary embodiment. In this exemplary embodiment, a permanent magnet (58) shown in FIG. 5-3 is placed along the length of the electric motor (50). The magnet is of a planar shape, however, other suitable shapes are also contemplated in the present disclosure. The magnetization goes through several N (59) to S (60) transitions along the planar surface. A sliding actuator (51) is shown in FIG. 5-2, and is configured when in use to slide along the length of the magnet (58). Attached to the actuator (51) is a light source and at least two light sensors (here shown as 3 optical elements (54)) that are position on a planar side of the control board (53). Adjacent to the light source, depicted in FIG. 5-3 is a sinusoidal gradient encoder (57) of alternating dark areas and light areas to reflect the light into the at least two light sensors. The sinusoidal gradient encoder (57) is located on the underside of the top cover (56) of the electric motor. Attached to the actuator (51) are a plurality of coils (55), positioned to interact with the permanent magnet to cause movement of the motor. A cable (52) runs from the control board (53) on the actuator to an external system. The control electronics and microprocessor may be on the control board, or at the other end of the cable (52), or a split across both. FIGS. 5-1, 5-2 and 5-3 are arranged to show the gradient encoder (57) above the light source and the coils (55) above the magnet (58), however, other suitable adjacent arrangements on the top, bottom, left or right sides are also contemplated in the present disclosure.

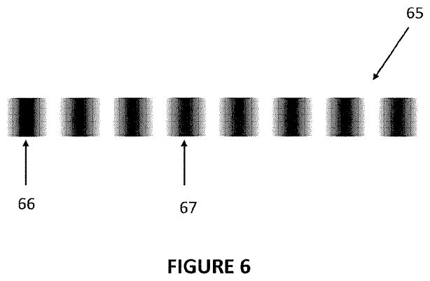

FIG. 6 shows a linear continuous tone sinusoidal gradient (65) of alternating dark areas and light areas, according to at least one exemplary embodiment. In FIG. 6 one of the dark patterns (66) is darker at least in part then the other darker patterns, for example (67). In at least one embodiment, where multiple repetitions are performed and where one of the gradients in the pattern is different in intensity, in that the darkest or lightest point extends a bit beyond the others' darkest or lightest points. The sinusoidal gradient of FIG. 6 allows for the determination of a datum or origin on the motor body. The approach shown in FIG. 6 may also be used in non-linear sinusoidal gradients, for example, the circular one shown in FIG. 1B.

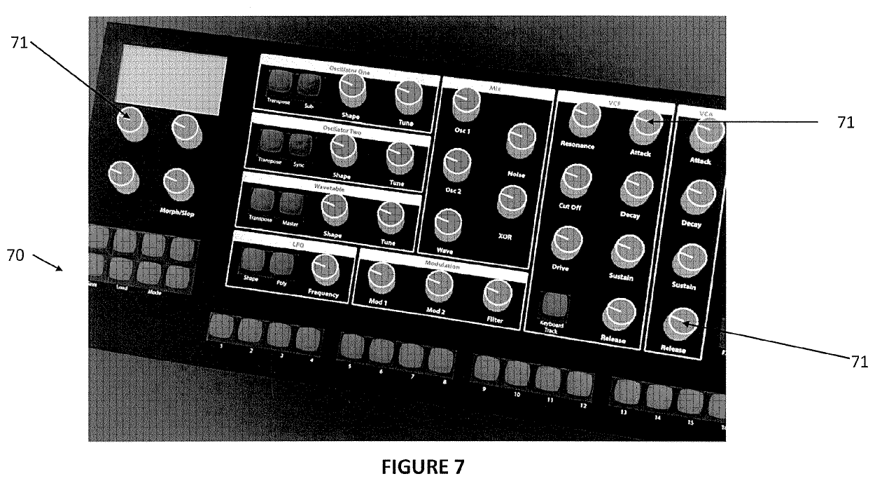

FIG. 7 is an illustration of a control panel (70) for sound applications where the electric motors (71) use the optical encoder, according to at least one exemplary embodiment. There are many other applications for electric motors that use optical encoders. The application of optical encoders with electric motors is extensive and in many different industries.

### Examples

Further advantages of the claimed subject matter will become apparent from the following examples describing certain embodiments of the claimed subject matter.

1. An optical position encoder system comprising:
at least one sinusoidal gradient for use with an electric motor, the at least one sinusoidal gradient having a dark to light pattern on at least one surface of the at least one gradient; and
a control board configured to be affixed to the motor and to at least in part control the motor's movement, the control board comprising:
a light source and at least two light sensors position on a planar side of the control board, the at least two light sensors being spaced at a distance apart from each other and the light source, wherein the light source is configured to direct light onto the at least one sinusoidal gradient's dark to light pattern, and the at least two light sensors are configured receive reflected light from the at least one sinusoidal gradient and provide at least two output signals; and
at least one microprocessor operatively connected to the motor, the at least one microprocessor being configured to receive the at least two output signals from the at least two sensors and used those signals to determine at least in part the motor's movement, position or combinations thereof.

2. An optical position encoder system comprising:
at least one sinusoidal gradient that is configured to be positioned on a surface of a multi-phase electric motor, the sinusoidal gradient having a dark to light pattern on at least one surface of the at least one gradient; and
a control board configured to be affixed to the motor and to at least in part control the motor's movement, position or combinations thereof, the control board comprising:
a light source and at least two light sensors position on a planar side of the control board, the at least two light sensors being spaced at a distance apart from each other and the light source, wherein the light source is configured to direct light onto the at least one sinusoidal gradient's dark to light pattern, and the at least two light sensors are configured receive reflected light from the at least one sinusoidal gradient ramp and provide at least two output signals; and
at least one microprocessor operatively connected to the motor, the at least one microprocessor being configured to receive the at least two output signals from the at least two sensors and used those signals to determine the motor's movement, position or combinations thereof.

3. An optical position encoder system comprising:
at least one sinusoidal gradient that is configured to be positioned on a surface of a multi-phase electric motor, the at least one sinusoidal gradient having a dark to light pattern on at least one surface of the at least one sinusoidal gradient; and
a control board configured to be affixed to the motor and to at least in part control the motor's movement, position or combinations thereof, the control board comprising:
a light source and at least two light sensors position on a planar side of the control board, the at least two light sensors being spaced at a distance apart from each other and the light source, wherein the light source is configured to direct light onto the sinusoidal gradient's dark to light pattern, and the at least two light sensors are configured receive reflected light from the sinusoidal gradient and provide at least two output signals in quadrature phase;
at least one microprocessor operatively connected to the motor, the at least one microprocessor being configured to receive the at least two output electronic signals from the at least two sensors and used those signals to determine the motor's movement, position or combinations thereof; and
wherein the system is configured to allow the reflected light from the gradient's light to dark pattern to be repeated a plurality of times and use a plurality of the at least two output electronic signals in order to reduce the optical positions encoder's signal to noise ratio and to determine the motor's movement, position or combinations thereof.

4. The system of any of the examples 1 to 3, wherein the at least two output signals are in quadrature phase.

5. The system of any of the examples 1 to 3, wherein the at least two output signals are substantially in quadrature phase.

6. The system of any of the examples 1 to 5, wherein the at least one sinusoidal gradient is a ramp.

7. The system of any of the examples 1 to 6, wherein the at least two light sensors comprise a first sensor and a second sensor and the distance between the first sensor and the second sensor is selected such that reflected light received at the first sensor is one quarter of a wave of the sinusoidal gradient pattern compared to reflected light received at the second sensor.

8. The system of any of the examples 1 to 7, wherein the at least two light sensors comprise a first sensor and a second sensor and the distance between the first sensor and the second sensor results in reflected light received at the first sensor is one quarter of a wave of the sinusoidal gradient pattern compared to reflected light received at the second sensor.

9. The system of any of the examples 1 to 8, wherein the motor is a multi-phase electric motor.

10. The system of any of the examples 1 to 9, wherein the at least one sinusoidal gradient is configured to be positioned on a surface of the motor.

11. The system of any of the examples 1 to 10, wherein the at least one sinusoidal gradient is configured to be positioned on a moving surface of the motor.

12. The system of any of the examples 1 to 11, wherein the at least one sinusoidal gradient is configured to be positioned on a moving surface.

13. The system of any of the examples 1 to 12, wherein the at least one sinusoidal gradient is configured to be positioned on a surface.

14. The system of any of the examples 1 to 13, wherein the at least one sinusoidal gradient is an etched pattern, a printed pattern, or combinations thereof.

15. The system of any of the examples 1 to 14, wherein the system is configured to allow the reflected light from the gradient's light to dark pattern to be repeated a plurality of times and use a plurality of the at least two output electronic signals in order to reduce the optical positions encoder's signal to noise ratio.

16. The system of any of the examples 1 to 15, wherein the system is configured to allow the reflected light from the gradient's light to dark pattern to be repeated a plurality of times and use a plurality of the at least two output electronic signals in order to reduce the optical positions encoder's signal to noise ratio and to determine the motor's movement, position or combinations thereof.

17. The system of any of the examples 1 to 16, wherein the at least two light sensors are on opposite sides of the light source.

18. The system of any of the examples 1 to 17, wherein the at least two light sensors are on not on opposite sides of the light source.

19. The system of any of the examples 1 to 18, wherein the control board is configured to the at least two output signals to determine the motor's movement, position or combinations thereof.

20. The system of any of the examples 1 to 19, wherein the control board is configured to the at least two output signals to determine the motor's dynamic movement, position or combinations thereof.

21. The system of any of the examples 1 to 20, wherein the at least two output signals are electronic signals.

22. The system of any of the examples 1 to 21, wherein one sinusoidal cycle of the at least one sinusoidal gradient is used to determine with substantial precision the position of the motor.

23. The system of any of the examples 1 to 22, wherein the at least one sinusoidal gradient's light to dark pattern is repeated on the gradient's surface a plurality of times.

24. The system of any of the examples 1 to 23, wherein the at least one sinusoidal gradient's light to dark pattern is repeated at least four times.

25. The system of any of the examples 1 to 24, wherein each of the at least one sinusoidal gradient's light to dark pattern is substantially the same in appearance.

26. The system of any of the examples 1 to 25, wherein at least one of the at least one sinusoidal gradient's light patterns or dark patterns is not substantially the same in appearance as the gradient's other light to dark patterns.

27. The system of any of examples 1 to 26, wherein the light source is an LED.

28. The system of any of examples 1 to 27, wherein the at least two light sensors receive a sinusoidal ramp signal.

29. The system of any of examples 1 to 28, wherein the at least two light sensors receive a substantially sinusoidal ramp signal.

30. A multi-phase electric motor with an optical position encoder for determining the positioning, movement, or combinations thereof of the motor comprising:
at least one sinusoidal gradient pattern, varying from light to dark, on a moving portion of the body of the electric motor;
a light source attached to the body of the optical position encoder control board, that directs light onto the at least one sinusoidal gradient pattern;
a first light sensor attached to the control board that measures reflected light off the sinusoidal gradient pattern, and a second light sensor attached to the control board that measures reflected light off the sinusoidal gradient pattern, wherein the distance between the first sensor and the second sensor is selected such that the reflected light received from first sensor is one quarter of a wave of the sinusoidal gradient pattern compared to the reflected light received at the second sensor;
an electronic control system, attached at least in part to the control board, that determines the positioning, movement, or combinations thereof of the electric motor, by converting the amplitude of the light into an electrical amplitude from the first sensor and the second sensor and controlling the electrical current into each of the phases of the electric motor; and
wherein the multi-phase electric motor with optical position encoder allows the reflected light from the sinusoid light to dark pattern to be repeated a plurality of times and uses that sensor data in order to reduce the optical position encoder's signal to noise ratio and to control the motor's position measurement.

31. A method of using optical position encoder system to control a multi-phase electric motor, the method comprising:
using a control board configured to be affixed to the motor and to at least in part control the motor's movement, the control board comprising:
using a light source and at least two light sensors position on a planar side of the control board, the at least two light sensors being spaced at a distance apart from each other and the light source, wherein the light source is configured to direct light onto the at least one sinusoidal gradient's dark to light pattern, and the at least two light sensors are configured receive reflected light from the at least one sinusoidal gradient and provide at least two output signals; and
using at least two light sensors to collect light signals from the reflect light off the at least one gradient, wherein the at least two light sensors are spaced from each other;
converting the collected light signal into electronic signals by the at least two light sensors;
sending the electronic signals to an electronic control system; and
wherein the electronic control systems use the electronic signals to at least in part determined the position, movement of the electric motor.

32. One or more computer-readable non-transitory storage media embodying software that is operable when executed to operate any of the systems of examples 1 to 29.

33. A system comprising: one or more processors; and one or more memories coupled to the one or more processors comprising instructions executable by the one or more processors, the one or more processors being operable when executing the instructions to operate any of the systems of examples 1 to 29.

34. A method of using an optical position encoder system to control an electric motor using any of the systems of examples 1 to 29.

Any description of prior art documents herein, or statements herein derived from or based on those documents, is not an admission that the documents or derived statements are part of the common general knowledge of the relevant art.

While certain embodiments have been shown and described herein, it will be obvious to those skilled in the art that such embodiments are provided by way of example only.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It is to be understood that the present disclosure is not limited to the disclosed embodiments and is intended to cover various modifications and equivalent arrangements included within the spirit and scope of the present disclosure. Also, the various embodiments described above may be implemented in conjunction with other embodiments, e.g., aspects of one embodiment may be combined with aspects of another embodiment to realize yet other embodiments. Further, independent features of a given embodiment may constitute an additional embodiment.

1. (canceled)

2. (canceled)

3. An optical position encoder system comprising:
at least one sinusoidal gradient that is configured to be positioned on a surface of an electric motor, the at least one sinusoidal gradient having a dark to light pattern on at least one surface of the at least one sinusoidal gradient; and
a control board configured to be affixed to the motor and to at least in part control the motor's movement, position or combinations thereof, the control board comprising:
a light source and at least two light sensors position on a planar side of the control board, the at least two light sensors being spaced at a distance apart from each other and the light source, wherein the light source is configured to direct light onto the sinusoidal gradient's dark to light pattern, and the at least two light sensors are configured receive reflected light from the sinusoidal gradient and provide at least two output signals in quadrature phase;
at least one microprocessor operatively connected to the motor, the at least one microprocessor being configured to receive the at least two output electronic signals from the at least two sensors and used those signals to determine the motor's movement, position or combinations thereof; and
wherein the system is configured to allow the reflected light from the gradient's light to dark pattern to be repeated a plurality of times and use a plurality of the at least two output electronic signals in order to improve the optical position encoder's signal to noise ratio and to determine the motor's movement, position or combinations thereof; and wherein at least one of the at least one sinusoidal gradient's light patterns or dark patterns is not substantially the same in appearance as the gradient's other light to dark patterns.

4. The system of claim 1, wherein the difference in one or more of the peaks or one or more of the troughs is extended in amplitude, such that the at least two output signals are substantially in quadrature phase.

5. The system of claim 3, wherein the at least one sinusoidal gradient is a continuous tone.

6. (canceled)

7. (canceled)

8. The system of claim 3, wherein the motor is a multi-phase electric motor.

9. The system of claim 3, wherein the at least one sinusoidal gradient is configured to be positioned on moving surface of the motor.

10. (canceled)

11. (canceled)

12. The system of claim 3, wherein the at least two light sensors are on opposite sides of the light source or are not on opposite sides of the light source.

13. (canceled)

14. (canceled)

15. (canceled)

16. The system of claim 3, wherein at least one sinusoidal cycle of the at least one sinusoidal gradient is used to determine with substantial precision the position of the motor.

17. (canceled)

18. The system of claim 16, wherein the at least one sinusoidal gradient's light to dark pattern on the gradient's surface is repeated at least two times.

19. The system of claim 3, wherein the at least one of the at least one sinusoidal gradient's light patterns or dark patterns is not substantially the same in appearance as the gradient's other light to dark patterns and this is used to determine the absolute position of the motor.

20. (canceled)

21. (canceled)

22. One or more computer-readable non-transitory storage media embodying software that is operable when executed to operate the systems of claim 3.

23. The system of claim 4 wherein the at least one sinusoidal gradient is a continuous tone.

24. The system of claim 23, wherein the motor is a multi-phase electric motor.

25. The system of claim 24, wherein the at least one sinusoidal gradient is configured to be positioned on a moving surface of the motor.

26. The system of claim 25, wherein the at least two light sensors are on opposite sides of the light source or are not on opposite sides of the light source.

26. The system of claim 25, wherein at least one sinusoidal cycle of the at least one sinusoidal gradient is used to determine with substantial precision the position of the motor.

27. The system of claim 26, wherein the at least one sinusoidal gradient's light to dark pattern on the gradient's surface is repeated at least two times.

28. The system of claim 27, wherein the at least one of the at least one sinusoidal gradient's light patterns or dark patterns is not substantially the same in appearance as the gradient's other light to dark patterns and this is used to determine the absolute position of the motor.

29. One or more computer-readable non-transitory storage media embodying software that is operable when executed to operate the system of claim 28.

30. A system comprising: one or more processors; and one or more memories coupled to the one or more processors comprising instructions executable by the one or more processors, the one or more processors being operable when executing the instructions to operate the system of claim 3.

31. A system comprising: one or more processors; and one or more memories coupled to the one or more processors comprising instructions executable by the one or more processors, the one or more processors being operable when executing the instructions to operate the system of claim 28.
